(19) United States
(12) Patent Application Publication
(10) Pub. No.: US 2018/0165463 A1
(43) Pub. Date: Jun. 14, 2018

(54) RESTRICTED CONTENT EVALUATION SYSTEMS AND METHODS

(71) Applicants: Lori McCreary, Beverly Hills, CA (US); Kevin Corbett, Beverly Hills, CA (US)

(72) Inventors: Lori McCreary, Beverly Hills, CA (US); Kevin Corbett, Beverly Hills, CA (US)

(21) Appl. No.: 15/842,551

(22) Filed: Dec. 14, 2017

Related U.S. Application Data
(60) Provisional application No. 62/434,332, filed on Dec. 14, 2016.

(51) Int. Cl. G06F 21/60; H04L 12/58; G06F 17/30

(52) U.S. Cl. CPC G06F 21/604; G06F 17/30864; H04L 51/10; H04L 51/12

(57) ABSTRACT

The preset invention is directed to a restricted content evaluation system including: a processor, having a memory and configured by code to receive at least one message having a content portion containing at least one content access link from a message platform. The processor is configured to extract at least one content access link from the message and compare the extracted content access link to one or more entries stored in an access link database. The content of the message is amended such that the restricted access link is removed where the extracted content access link matches an entry in the database. The amended message is provided to the message platform for routing to the intended recipient.

### CROSS-REFERENCE TO RELATED APPLICATIONS

This application claims priority to U.S. Provisional Patent Application Ser. No. 62/434,332 of the same title, filed on Dec. 14, 2016, which is incorporated by reference herein in its entirety.

### FIELD OF THE INVENTION

The present invention is directed to communication systems that evaluates electronically sent messages for any links to unauthorized content, and scan resources associated for with the links for unauthorized content, and to methods of use of such systems.

### BACKGROUND OF THE INVENTION

The near ubiquity of portable digital communication devices has proven to be a boon for the entertainment industry. Between social media, on-line media platforms, and on-demand entertainment, it has never been easier for content producers to interact with content consumers. However, the expansion of on-line media offerings comes with unintended consequences. Copyrighted content, such as movies, TV shows, music and the like can be copied and spread online without the consent of the copyright holder. There are numerous mechanisms for sharing unauthorized copies of content. One such method involves hosting the unauthorized copy of content on a website and distributing, in lieu of the content itself, a URL link to access the content. In addition to depriving the content creators of due compensation for the content, such links can be used to spread malicious code and infect devices, computers and networks with computer viruses or security vulnerabilities. For example, links can be purported to direct a user's web browser to a copy of unauthorized content, but in fact direct the user to a site containing malicious code designed to compromise the user's security and identity.

Additionally, a recipient of such unauthorized content might have alternative, approved access to the same content, such as through a media subscription service. Thus, accessing the restricted content puts the recipient at an unnecessary legal and security risk for content that might be accessible through approved channels.

What is therefore needed in the technical field are systems, methods and computer program products for monitoring communications and actively removing links to restricted content in messages sent over communication networks, and if the message is encrypted or otherwise undecipherable, enables content to be scanned for watermarks and other indicia of authorized provision. Furthermore, what is needed is a library or list of authorized content that can be substituted in any message that has been monitored and identified as including links to restricted content, or can redirect a browser or content player to authorized content, such that the intended recipient is still able to access the referenced content, but from a reputable and secure vendor.

### SUMMARY OF THE INVENTION

Certain embodiments of the invention are directed towards systems, methods and computer program products for a restricted content evaluation system. In one embodiment, the preset invention is directed to a restricted content evaluation system including: a processor, having a memory and configured by code to receive at least one message having a content portion containing at least one content access link from a message platform. The processor is further configured to extract at least one content access link from the message and compare the extracted content access link to one or more entries stored in an access link database. The content of the message is amended such that the restricted access link is removed where the extracted content access link matches an entry in the database. The amended message is provided to the message platform for routing to the intended recipient. Through operation of the systems, methods, and computer program products according to the invention, messages are selectively altered after being transmitted by a source to better ensure that the destination is precluded from receiving a link to restricted content.

In a further embodiment, a method is provided for sanitizing a message by removing or editing restricted access content links contained within the message. In one implementation, the method comprises receiving, by a processor configured with code, at least one message having a content portion containing at least one content access link from a message routing appliance and a routing portion containing intended recipient data, extracting, by a processor configured with code, the at least one content access link from the message, evaluating the content referred to by the access link, comparing the content of the access link to one or more entries stored in a content identification database, amending, by a processor configured with code, the content portion of the at least one message to remove the content access link when the extracted content identification database is matched to an entry in the database, and providing, by a processor configured with code, the amended message to the message routing appliance.

Embodiments of the present invention further provide a message evaluation system for processing restricted content. The message evaluation system includes a message server configured to delay the delivery of a message sent using the message server until receipt of a pass value above a given threshold value, an access link database, and a processor, having a memory and configured by code implemented thereto receive from a message server, at least one content access link obtained from a message sent using the message server, compare the received content access link to one or more entries stored in the access link database, generate a delivery value greater than the pass value threshold where the received content access link is matched to an entry in the database and a delivery value less than the pass value threshold where the received content access link is not matched to an entry in the database, and provide at least the delivery value to the message server as a pass value.

Further embodiments of the present invention provide a resource evaluation system for processing restricted content. The resources evaluation system includes a content database, and a processor, having a memory and configured by code implemented thereto receive at least request containing at least one content access link from a sender device, extract the at least one content access link from the request, access a database including a list of restricted access link entries, compare the extracted content access link to the list of the database, remove the content access link if the extracted content is matched to an entry in the database, and provide a notification that access has been restricted to the content access link.

Embodiments of the present invention also provide a method of managing a request for a restricted access content link to a non-restricted content link. The method comprises receiving, by a processor configured with code, a request to access a restricted access content link, extracting, by a processor configured with code, the restricted access content web link from the request, evaluating content referred to by the restricted content access link, comparing the content of the access link to one or more entries stored in a content identification database, and amending, by a processor configured with code, the content access link when the extracted content identification database is matched to an entry in the database so as to redirect the request to a non-restricted content link.

Additionally, embodiments of the present invention provide a method of preventing playback of restricted media content. The method comprises receiving a link to media content, prior to playback of the media content, scanning the media content for a content fingerprint indicative of whether the media content is authorized, and if a content fingerprint indicative of an authorized source is found in the media content a media player is activated to playback the media content. Otherwise an industry identification in the media content is determined and the industry identification of the media content is sent to an authorized content source to provide the ability to obtain an authorized version of the media content.

Additionally, embodiments of the present invention provide a method of preventing playback of restricted media content. The method comprises accessing an instruction set for various watermarks stored in a database and accessing media content for evaluation. The method also comprises evaluating the media content according to the instruction set for each watermark stored in the database and identifying a watermark within the evaluated content.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for removing restricted access content links from electronic messages according to one embodiment of the present invention.

FIG. 2 presents a flow diagram of the steps to remove restricted access content links from electronic messages according to one embodiment of the present invention.

FIG. 3 presents a block diagram illustrating a processor configured by a set of modules to implement the steps of removing restricted access content links according to one embodiment of the present invention.

FIG. 4 presents an illustration of an exemplary embodiment of the present invention.

FIG. 5 presents a block diagram illustrating message modification steps according to one embodiment of the present invention.

FIG. 6 presents a block diagram illustrating message modification steps according to one embodiment of the present invention.

FIG. 7 is a schematic overview of a multi-level method to prevent access to restricted content according to an embodiment of the present invention.

FIG. 8 a block diagram illustrating another processor (resource evaluation server) configured by a set of modules to implement the steps of removing restricted access content links according to one embodiment of the present invention.

### DETAILED DESCRIPTION OF CERTAIN EMBODIMENTS OF THE INVENTION

By way of overview, various embodiments of the described systems and methods described herein are directed towards evaluating an electronic message sent through a communication network for restricted access content links, and/or towards evaluating web site data and media content for restricted access.

### Overview

As a broad overview, a first computer configured with code receives one or more messages, or the content of one or more messages, and evaluates the message for restricted content access links. The evaluation is made in regard to a database of content identifiers for known content. Content referred to by the link is evaluated against the content database. Where content matches the entries of the content database, or the link itself is matched to a database of known restricted content access links, the link is removed from the message. In messages where the link has been deleted, the content of the message can be revised further to include a new link referencing the same content, but from an approved or authorized source, or a text indicator to indicate that the content of the message has been modified. In still a further arrangement, the new link references different content. For instance, the link can be to an excerpt or truncated version of the restricted media content, or to content that explains that the sender's link has been omitted because it concerns pirated or unauthorized content. Regardless of nature of the modified content, the modified message is provided back to the messaging platform and the message is routed to its intended recipients(s).

As messaging platforms now often encrypt communications, it is not always possible to evaluate message content directly. To prevent access to restricted content, it is important to also have the capability to evaluate a URL link and the content therein after a link has been accessed by the intended recipient, e.g., via a web browser, but before any content associated with the link has been played back by the recipient device. A second computer configured with code receives one or more communications received by a web platform and evaluates metadata and media content in such communications for restricted content access links.

In addition, a further level of protection against unauthorized access can be provided at the recipient user device level. Typically, playback of video or audio content requires the recipient device to launch a media player program. Before a media player program plays back the content, the media data can be intercepted by a separate program such as API pre-installed on the user device, or linked with the media player. The intercepted content can be scanned for content fingerprints indicative of authorized or unauthorized sources. For example, the content can be received as a file download or a digital stream. In either scenario, the processor is configured to evaluate the accessed content, for an authorization flag, such as watermark and content ID. If a content fingerprint, such as a watermark is detected, the media data can be released to the media play for playback, otherwise the content is deemed unauthorized, and the content is not displayed to the user. In one or more implementations, the processor, upon restricting playback can generate one or more links to authorized content and displays those links to the user.

In an alternative configuration, where the user manually enters a URL or makes a HTTP request receive content, either in the form of a direct file download, or as a data stream, the processor of the user device is configured by code to evaluate the content accessed prior to playing. For instance, the content is evaluated for watermarks or against a content ID database to determine if the content is authorized. In this way, where the link or resource identifier for restricted content is not transmitted via an electronic message, the resource link may still be evaluated for restricted content by the user device.

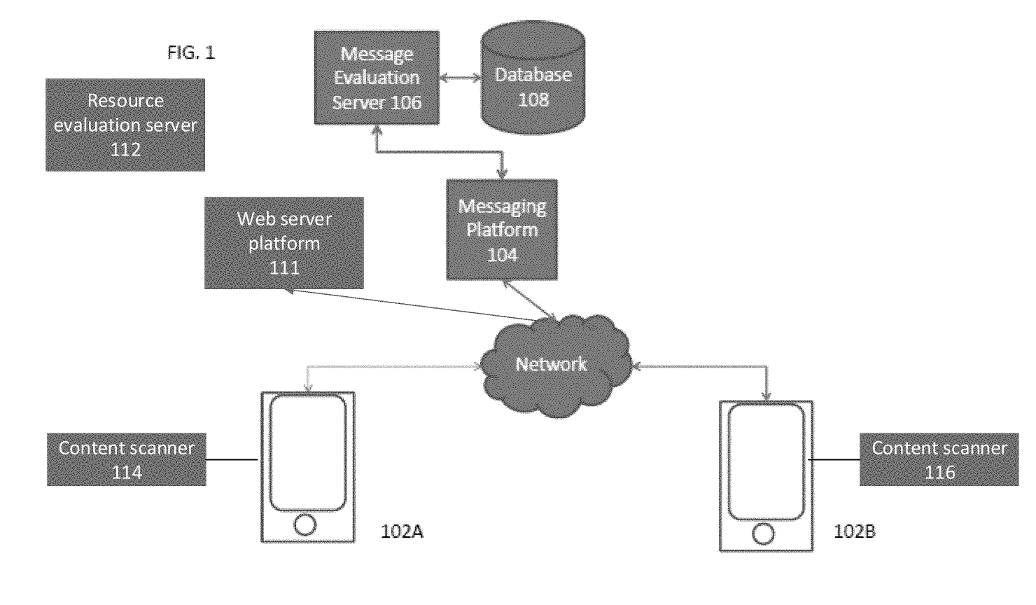

Turning to FIG. 1, an evaluation system is configured to receive a communication generated from a sender device 102A. The communication can be a message that includes a link (e.g., URL) to a remote resource that includes restricted access content. In some instances, the messaging device 102A provides the message containing a restricted access content link to a messaging platform 104 for routing to an intended recipient 102B. The message evaluation server 106 evaluates messages sent over the messaging platform 104 and generates, when necessary, modifications to the message. The modified message is sent back to the messaging platform 104 and through one or more communication networks (e.g. Internet) reaches an intended recipient using receiving device 102B. As will be appreciated from the following discussion, the message evaluation server 106 can be independent of the messaging platform, and can communicate with numerous messaging platforms to provide message evaluation services.

In other instances, such as when the message from the sender device 102A is encrypted by the sender or message platform 104, the evaluation server may not have or be able to obtain the keys for de-encrypting the messages it evaluates. Accordingly, in such instances, the restricted access link cannot be evaluated or replaced, if indicated. The message, including the restricted access link therefore reaches the receiving device 102B. If the restricted access link is a URL, the receiving device 102B can click the link which launches a browser program (e.g., Internet Explorer, Chrome, Firefox) to attempt to access the content associated with the URL. Here, the sender device 102B sends a communication, via a network, to a web server platform 111 to obtain access to the URL from the network. A resource evaluation server 112 evaluates the communication sent over the web server platform 111 to determine whether the URL is associated with restricted access content. If so, the resource evaluation server can intervene to prevent the browser from accessing the web page(s) associated with the URL. For instance, in one implementation, the browser is equipped with a content verification module that causes the browser to delay accessing the content until one or more access flags are received from the resource evaluation server 112. Here, upon selecting the URL, the browser sends the link to the resource evaluation server 112 instead of requesting the content from the link source. The resource evaluation server then accesses the content provided by the URL and evaluates it for restricted content, such as by scanning the content for a content ID or watermark. Where no content ID or watermark is found, the resource evaluation server 112 sends a flag or signal back to the browser, which redirects the user to a different URL or disables URL. For instance, the redirected URL might contain content indicating that the content URL contained restricted content. In some implementations, the resource evaluation server can send a communication to the receiver device 102B that causes a notice to be displayed on the receiver's browser. For example, the notice can state that the URL is restricted, and can include a list of other links to the content that are authorized. The resource evaluation server 112 can be co-located with the message evaluation server and can be a modified version of the same evaluation program adapted to parse HTML or XML code. Alternatively, the resource evaluation server 112 can be independent from the message evaluation server 106. In either case, the resource evaluation server 112 can be independent of the web server platform 111.

In one or more additional implementations, the content evaluation module includes one or more URL patterns. Such patterns can be stored within the memory of the browser. When the URL matches a pattern stored in the browser, the browser does not send the URL to the resource evaluation server 112. Alternatively, the browser can be configured to access any link, without prior evaluation by the resource evaluation server 112, unless the URL matches the pattern provided by the content evaluation module.

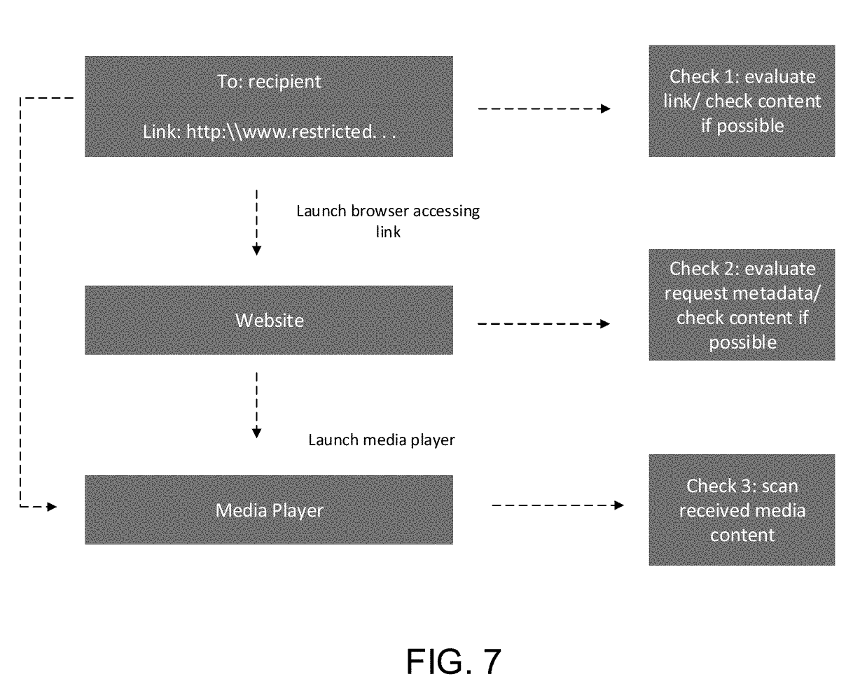

As there are instances in which restricted content cannot be determined from the metadata of a link (e.g., the link is not listed on a database of restricted sites), in some embodiments, a further level of protection can be added at the user-device level. Sender and receiver devices 102A, 102B can include a content scanner application 114, 116, respectively (shown outside of devices 102A, 102B for ease of illustration). That is to say, the code for executing the content scanner applications 114, 116 can be preinstalled on devices 102, 102B. The content scanners 114, 116 preferably operate in association with one or more media player programs installed on the devices. For example, the content scanners 114, 116 can be applications that are activated automatically when a media player program is launched. Content scanners 114, 116 are configured to search for certain content fingerprints indicating authorized content, such as a content ID or a watermark, within audio, visual or video (media) content. Content scanners 114, 116 search for the indicia before the media player plays back the actual content. If a scanner finds a content ID or watermark indicating the content is authorized, a flag can be set to allow the media player to play back the media content. If a content ID or watermark is not found, the media player can be prevented from playing back the media content, and a notice can be displayed on the user device that the content is restricted. In some embodiments, the scanners 114, 116 can additionally deliver a communication to a local program or over the network to one or more servers to determine what the specific content is (e.g., a particular movie or song). Once the content is determined, the content scanner can cause a communication to be sent to the one or more of the evaluation servers 106, 112 to determine whether authorized versions of the content are available and can be substitute for the restricted content. In certain embodiments, the content scanners 114, 116 operate in conjunction with network resources, e.g., for databases updates of relevant watermarks or content IDs FIG. 7 details a schematic overview of an embodiment of a method for evaluating and preventing access to restricted content using multiple levels of defense according to the present invention. At a first level, if a message is sent via a messaging platform (e.g., Twitter, SMS) to a recipient, the message is scanned for content locators (e.g., URLs), the URL is accessed and the obtained media content is evaluated to determine whether it contains restricted content by searching content fingerprints against one or more relevant databases. Remedial steps can be taken if restricted content is detected at this first level to prevent access to the resource by the recipient and to substitute authorized content.

For various reasons, including encryption of the message content, the first level of defense is not always sufficient to prevent access to restricted content. If the first level is breached, the recipient can launch the link to access the resource over a web server platform. At the second level of defense, code operates on or in conjunction with the web platform to evaluate whether a requested resource is restricted by searching content fingerprints or other metadata against one or more relevant databases. If it is determined that the content is restricted, remedial measures can again be taken to prevent access to the resource by the recipient and to substitute authorized content.

In some instances, the second level of defense is also not sufficient to prevent unauthorized access. For example, the URL can be new and not listed as a restricted link in relevant databases. Likewise, it is likely that the content fingerprint analysis has not covered all content, thus there will be scenarios where it will be difficult or impossible to determine if the content is restricted. Thus, in some cases, a recipient device can access and playback the media content associated with a restricted resource. Accordingly, a third level of protection reviews the actual media content at the device level to determine whether the content is restricted or authorized. The media content is scanned to determine whether it contains restricted or authorized content prior to playback of the content. In some implementations scanning can be initiated upon activation of the content and launch of a media player application and before the media player reads the content. In another implementation, the content, in whole or in part, is sent to the content evaluation server for classification or identification. Accordingly, over time restricted content will become identified such that subsequent access attempts will be prevented. Additionally, since the content evaluation server 112 is configured to communicate with multiple user devices, the distribution of new restricted content can be swiftly disrupted though the act of accessing such restricted content.

It is important to note that not all levels of defense need to be in operation and/or sequential, and each level of defense can be used alone or in combination with one or more of the other levels of defense. Additional levels of defense, i.e., additional code running on one or more end user devices, network servers, or any other processors involved in the communication, storage and identification of media content can be added at different nodes to prevent access and playback of restricted content.

Used herein, “processor” or “computer” refers one or more electronic devices (e.g. semiconductor based microcontrollers) configured with code in the form of software, to execute a given instruction set. For example, the message evaluation server 106, resource evaluation server 112, messaging platform 104, web server platform 111 and sender/receiver devices 102A-B each include one or more processing or computing elements executing commercially available or custom operating systems, e.g., MICROSOFT WINDOWS, APPLE OSX, UNIX or Linux based operating system implementations. In other implementations, the message evaluation server 106, resource evaluation server 112, messaging platform 104, web server platform 11, and devices 102A, 102B each include custom or non-standard hardware, firmware or software configurations. For instance, the processor or computer can include one or more of a collection of micro-computing elements, computer-on-chip, home entertainment consoles, media players, set-top boxes, prototyping devices or “hobby” computing elements. Such computing elements described are connected, directly or indirectly, to one or more memory storage devices (memories) to form a microcontroller structure. The memory is a persistent or non-persistent storage device that is operative to store an operating system for the processor in addition to one or more of software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules.

The computer memories may also comprise secondary computer memory, such as magnetic or optical disk drives or flash memory, that provide long term storage of data in a manner similar to the persistent memory device. In one or more embodiments, the memory of the processors provide for storage of application programs and data files when needed.

The processors or computers described are configured to execute code written in a standard, custom, proprietary or modified programming language such as a standard set, subset, superset or extended set of JavaScript, PHP, Ruby, Scala, Erlang, C, C++, Objective C, Swift, C#, Java, Assembly, Go, Python, Pearl, R, Visual Basic, Lisp, or Julia or any other object oriented, functional or other paradigm based programming language.

### End User Device(s)

With more particular reference to FIG. 1, devices 102A and 102B are used to compose, send and receive one or more electronic communications over a network using a messaging platform 104, or a web server platform 111. In one implementation, device 102A connects to the messaging platform 104 directly or web server platform 111, such through an internal local network. Alternatively, device 102A connects to the messaging platform 104 or web server platform 111 by first connecting to the Internet. As used herein, device 102A is a general or single purpose computing device configured by hardware or software modules to connect to a network. For example, the device 102A can be a personal communication device (smartphone, tablet computer, etc.), configured by one or more code modules to compose a message and send the composed message to an intended recipient, to access web-based resources and to playback media content. Device 102A utilizes wired or wireless communication means, such as, but not limited to CDMA, GSM, Ethernet, Wi-Fi, Bluetooth, USB, serial communication protocols and hardware to connect to one or more access points, exchanges, network nodes or network routers.

In one implementation, devices 102A, 102B are portable computing devices such as Apple iPad/iPhones®, Android® devices or other electronic devices executing a commercially available or custom operating system, e.g., MICROSOFT WINDOWS, APPLE OSX, UNIX or Linux based operating system implementations. In other implementations, devices 102A-B are, or include, custom or non-standard hardware, firmware or software configurations. Devices 102A, 102B can communicate with the one or more remote networks using USB, digital input/output pins, eSATA, parallel ports, serial ports, FIREWIRE, Wi-Fi, Bluetooth, or other communication interfaces. In a particular configuration, devices 102A, 102B are also configured, through hardware and software modules, to connect to one or more remote servers, computers, peripherals or other hardware using standard or custom communication protocols and settings (e.g., TCP/IP, etc.) either through a local or remote network or through the Internet.

The receiving device 102B is an electronic device configured to receive messages sent by the transmitting messaging device 102A, access resources on local networks and the Internet. Device 102B can also be a computing device configured to access messages directly or stored on a remote storage location, such as an online mailbox or network message center. In one particular implementation, the intended recipient is a single recipient. In alternative implementations, the intended recipient is a collection of recipients such as any user of a particular messaging service. For example, the intended recipient can be the users of a messaging platform where the viewers of the message can be limited to a pre-defined set (e.g. friend list), or encompass all of the users of the network.

### Message Content

In a particular implementation, the message transmitted by the messaging device 102A consists of alphabetic and numeric characters (e.g. Short Message Service (SMS) text communications). In a further implementation, the message is a multimedia message containing digital images, videos, and sound content, as well as ideograms (emoji, stickers, badges, icons etc.).

In one or more implementations, the message composed on or using the messaging device 102A, or being forwarded from such a device, includes both content information and routing information. The routing information includes the intended recipient(s) and any associated metadata. The content information includes, in one embodiment, a message to the recipient. In a further implementation, the message content includes resource links, such as a URL (universal resource locators) or domain URL extensions. The term “domain URL extension” (or also referred to as “domain extension” or “URL domain extension”) is intended to broadly cover many different types of portions of URL domains that individually or in combination with other URL data forms a URL domain. For example, a domain URL extension may express a top-level domain name portion of a URL domain, such as “.com” for a commercial URL. As a second example, a domain URL extension completes a domain name, including a top-level domain name portion, such as “restrictedcontent.com.” In a further implementation, a domain URL extension may complete a domain name URL identifying a path to a file or resource residing inside a server at a domain such as “restrictedcontent.com/videos/1111”.

One particular use of URLs is to link or reference an asset stored in a remote location, such as an audio video recording, movie, work, or program. Upon clicking on the link within the message, a user's computing device causes an application to launch to view the content. For example, where the URL references a location of video content, selecting the URL causes the messaging device 102B to initiate a web browser or other application that is configured to display the content referenced by the link.

While many URLs can be used to direct users to freely available media content (such as content hosted by http://www.youtube.com), it is also possible to generate links that reference unauthorized or restricted access copies of media content. As used herein, restricted access content refers to any content that is provided without express permission by the copyright holder. Likewise, links to such unauthorized content are referred to herein as restricted access content links.

As shown with reference to FIG. 1, the message generated by the messaging device 102A is routed (directly or through the Internet) to the messaging platform 104.

### Messaging Platform

In one particular implementation, the messaging platform 104 is a server, computing cluster, cloud platform or computing array, configured to directly, or through a communication linkage, communicate and exchange data with devices 102A, 102B.

As provided in the illustrated implementation, the messaging platform 104 is a computer server configured by code executing therein to accept electronic messages from the transmitting device 102A, and route the messages to the receiving device 102B based on user identification, IDs, or other logic rules. In one particular implementation, the messaging platform 104 is a network exchange, social media network, communications platform, messaging service, or other communication application or system. For example, the messaging platform 104 is a SMS text exchange server or an electronic message server configured to route messages from one smartphone device to another. Alternatively, the messaging platform 104 is a social network that permits users to broadcast messages using the messaging platform 104 (e.g. Twitter, Snapchat, Instagram) to users that subscribe to a particular message feed (i.e. followers, friends, etc.).

As used herein, the messaging platform 104 is configured with one or more remote or local data storage devices that store operating code, as well as user information. The messaging platform 104 is also configured to access remote resources such as third party vendor information, user data, and communication data from third parties through implementation of code modules.

### Message Evaluation Server

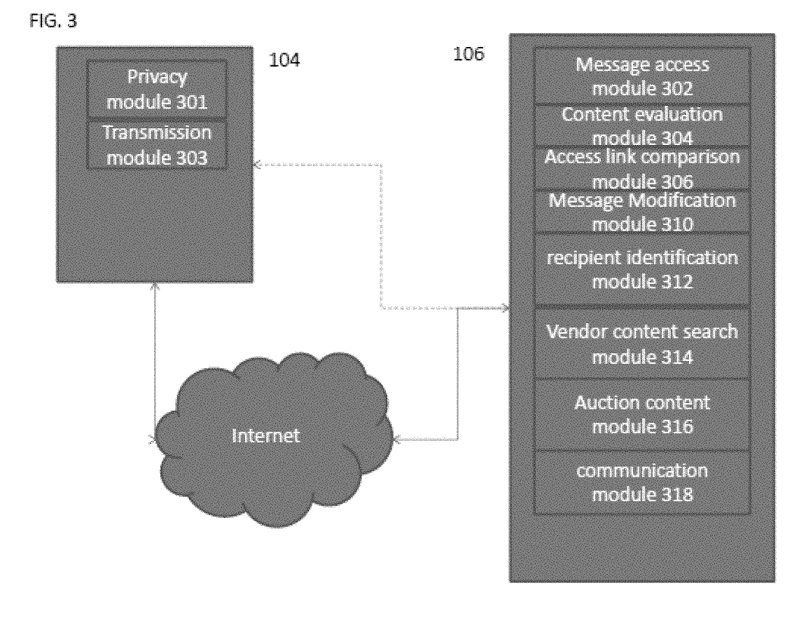

As the implementation of FIG. 1 illustrates, the message evaluation server 106 is used to evaluate the content of the message and, based on the content, modify the original message prior to delivery to the intended recipient(s). Referencing FIG. 3, the message evaluation server 106 includes one or more software or hardware modules executed on a computing device or processor that collectively configures a processor(s) or computer(s) to implement the functionality of evaluating and modifying messages. For example, the message evaluation server 106 is computing device, such as a server, cloud based system, or other computing environment distinct and remote from the messaging platform 104. In a particular implementation, the message evaluation server 106 includes a single processor, multiple discrete processors, a multi-core processor, or other type of processor(s) known to those of skill in the art, configured by code to evaluate the content of communications by and between messaging devices. In the illustrated implementation, the message evaluation server 106 exchanges data with one or more messaging platforms 104 through a network such as the Internet. Alternatively, as shown in dashed lines in FIG. 3, the message evaluation server 106 is in direct communication with the messaging platform 104 (as shown). In yet a further implementation, the functionality of the message evaluation server 106 is provided by one or more software applications executed by one or more of the processors of the messaging platform 104.

In one implementation, the message evaluation server 106 is independent of the messaging platform(s) 104 and communicates with numerous messaging platforms to provide message evaluation services. The message evaluation server 106 communicates with a database 108 which is maintained and or updated in view of information provided by content providers and other stake holders interested in arresting or curbing unauthorized content distribution through distributed computer networks such as the Internet, and through the auspices of established messaging platforms.

### Web Server Platform

In one particular implementation, the web server platform 111 is a server, computing cluster, cloud platform or computing array, configured to directly, or through a communication linkage, communicate and exchange data with devices 102A, 102B. The web server platform 111 is configured with one or more remote or local data storage devices (e.g. databases) that store operating code, as well as user information. The web server platform 111 is also configured to access remote resources such as third-party vendor information, user data, and communication data from third parties through implementation of code modules.

As provided in the illustrated implementation, the web server platform 111 is one or more computer servers configured by code executing therein to accept electronic communications devices 102A, 102B requesting resources accessible by a logical address included in the communications. The web server platform uses logical rules and other software algorithms to locate and initiate access of the resources (e.g., one or more web pages of a web site).

### Resource Evaluation Server

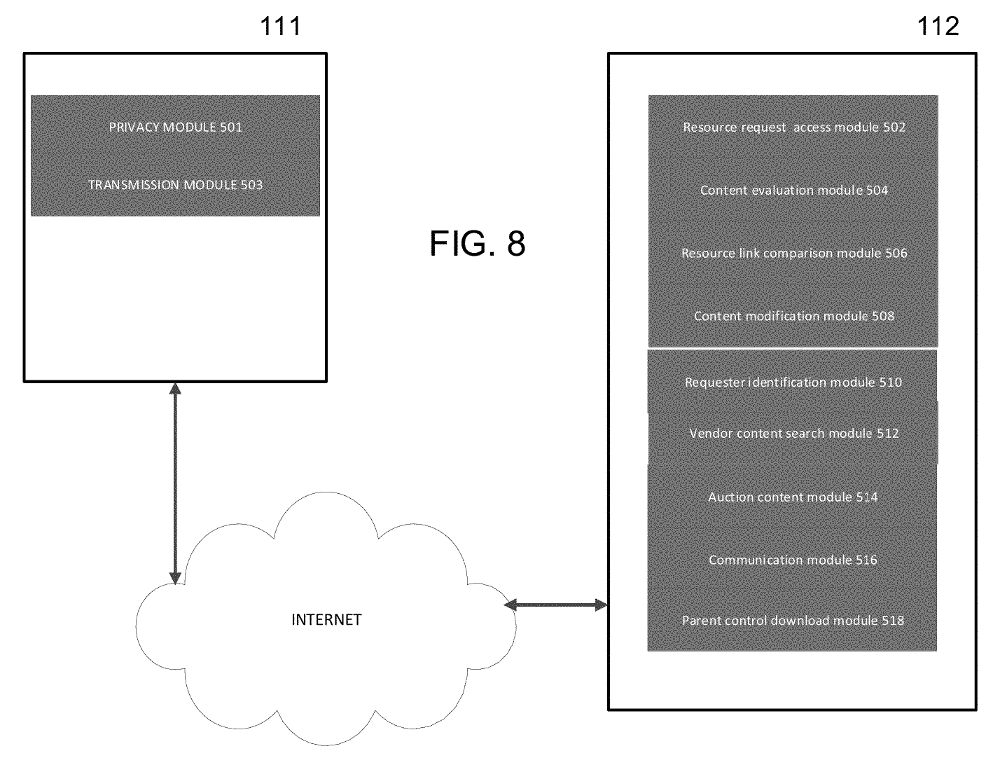

As the implementation of FIG. 1 illustrates, the message evaluation server 106 is used to evaluate the content of the message and, based on the content, modify the original message prior to delivery to the intended recipient(s). As noted above the resource evaluation server 112 can be implemented using the same device(s) and even code as the message evaluation server 106, as both operate to parse and extract URLs or URL domain extenders. The difference is that the message evaluation server parses message content to determine whether one or more URLs are present in a message (i.e., from a sender to a recipient) while the resource evaluation server parses URLs directly from a resource request communication issued by a web browser application. Referencing FIG. 8, the resource evaluation server 112 includes one or more software or hardware modules executed on a computing device or processor that collectively configures a processor(s) or computer(s) to implement the functionality of evaluating and modifying messages. For example, the message evaluation server 112 is a computing device, such as a server, cloud based system, or other computing environment distinct and remote from the web server platform 111.

In a particular implementation, the message evaluation server 112 includes a single processor, multiple discrete processors, a multi-core processor, or other type of processor(s) known to those of skill in the art, configured by code to evaluate the content of communications. In the illustrated implementation, the resource evaluation server 112 exchanges data with one or more web server platforms 111 through a network such as the Internet. Alternatively, as shown in FIG. 8, the resource evaluation server 112 is in direct communication with the web server platform 111 (as shown). In yet a further implementation, the functionality of the resource evaluation server 106 is provided by one or more software applications executed by one or more of the processors of the web server platform 111.

In one implementation, the message evaluation server 106 is independent of the messaging platform(s) 104 and communicates with numerous messaging platforms to provide message evaluation services. The message evaluation server 106 communicates with a database 108 which is maintained and or updated in view of information provided by content providers and other stake holders interested in arresting or curbing unauthorized content distribution through distributed computer networks such as the Internet, and through the auspices of established messaging platforms.

### Obtaining Messages

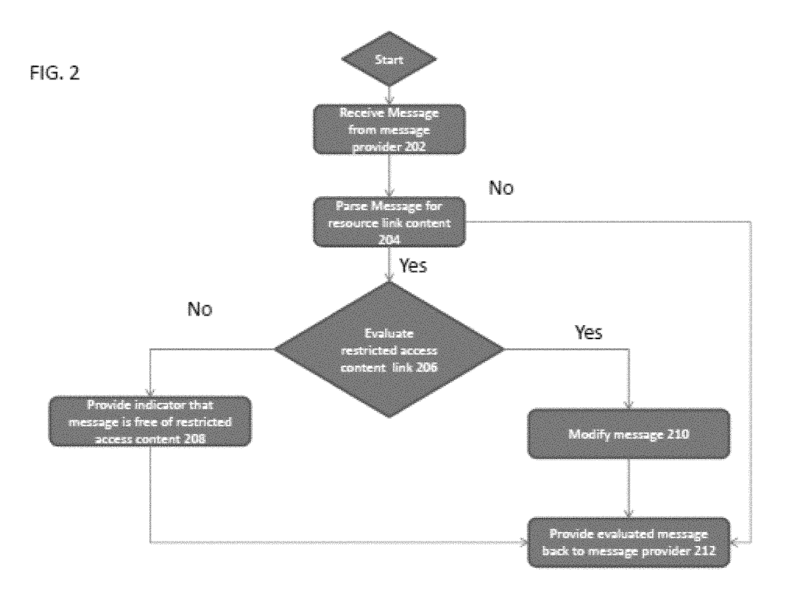

With particular reference to FIGS. 2 and 3, a message is sent from a device 102A to an intended recipient(s) using a particular messaging platform 104 (e.g. a SMS text message or Twitter® message). Here, the messaging platform 104 routs the message to the message evaluation server 106. For example, the messaging platform 104 is configured to store all incoming messages into temporary buffer or storage location. From this storage location, a copy of the message is provided to the message evaluation server 106. Building on this example, a message access module 302 configures a processor of the message evaluation server 106 to access or receive the message (or a copy thereof) from the messaging platform 104. In one implementation, the message access module 302 includes one or more submodules to configure communication between the processor and a message storage buffer or database. In one particular implementation, an authentication submodule configures the processor of the message evaluation server 106 to gain access to the message storage database by providing authentication data or credentials. Furthermore, a formatting submodule configures the processor(s) of the message evaluation server 106 to capture the content of the message and transform the content into a format or form suitable for use by the message evaluation server 106.

In the illustrated implementation, the entire message is received by the message evaluation server 106 for evaluation as in step 202. Where the entire message is not needed, such as when the message evaluation server 106 is incorporated as a module into the messaging platform 104, then only the content of the message is provided to a message evaluation module which is configured to operate similar to the message evaluation server 106, except that the module is under the control of the messaging platform 104, with the evaluation of links being done with reference to the database 108, either directly or through requests made by the message evaluation module to the message evaluation server 106. In one or more further implementations, the data corresponding to the message accessed by a processor configured by the message access module 302 includes a list or indicator of the intended recipient(s). In one particular implementation, the message accessed or received by the message evaluation server 106 is anonymized by a processor of the messaging platform 104 configured by a privacy module 301 prior to being sent. Here, the message evaluation server 106 is configured by code to extract the content of the message and send the extracted content along with one or more identifiers to the message evaluation server 106. The message identifiers permit the messaging platform 104, upon completion of the message analysis, to associate the message with the sender and receiver without disclosing the respective identities to the message evaluation server 106. In yet a further implementation, the message is partially anonymized by a processor of the messaging platform 104 configured by the privacy module such that only recipient data is provided along with the message to the message evaluation server 106.

As shown in step 204, the message evaluation server 106 evaluates the message to identify any content links found within the body of the message. Configured by a content evaluation module 304, a processor of the message evaluation server 106 extracts from the message the content portion for comparison and evaluation of the data found therein for access links, as indicated at step 206 and discussed below. In one particular implementation, the content evaluation module 304 includes one or more submodules to identify access-links within the extracted content. For example, a parsing submodule configures a processor of the message evaluation server 106 to evaluate the character strings or alphanumeric content of the message to identify patterns that correspond to resource links, such as URLs. For instance, the parsing submodule configures a processor of the message evaluation server 106 to identify strings of characters starting with “http:”, or “ftp:”, as such character strings are typically associated with resource links. Alternatively, where the messages contain html or other mark-up language, the parsing submodule configures the processor to identify resource links by identifying link reference tags (e.g. an “<a>” html element) that surrounds a string of characters. In yet a further implementation, the content evaluation module 304 includes one or more media element parser submodules. In one or more implementations where resource links are not provided as an alphanumeric string, but in the form of an embedded media player, the media element parser submodule of the content evaluation module 304 configures the processor to evaluate the display code, or mark-up language corresponding to a media player element found within the message to identify the source or link to the provided media or content. One or more additional submodules of the content evaluation module 304 are used to format or condition the extracted resource link for further use by the message evaluation server 106. For example, a format submodule extracts white space, or removes extraneous code from an identified access link prior to further evaluation.

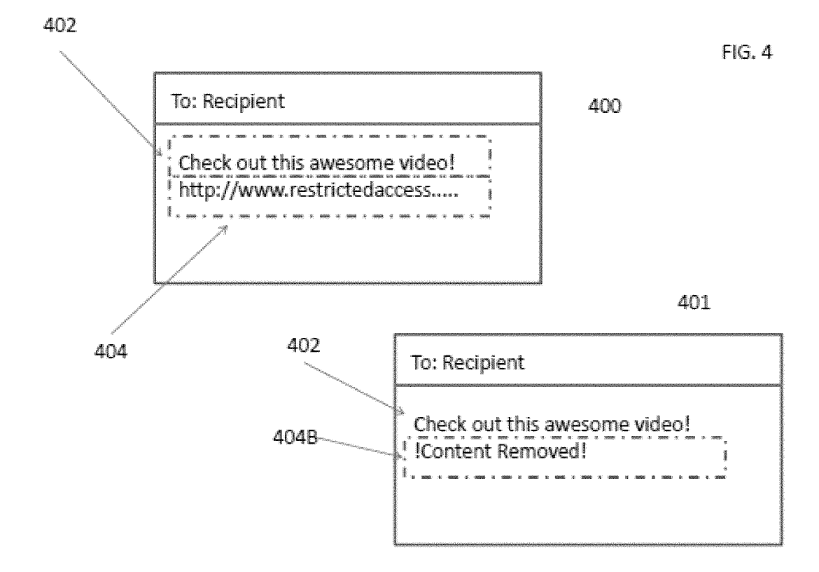

As shown in detail in FIG. 4, a representation of an unaltered message 400 is provided. The unaltered message contains a portion of the message content that is not a resource link 402 and a portion of the message content that is a resource link 404.

Returning to FIG. 2, where the content evaluation module 304 fails to identify any resource link within the message, the message is provided back to the messaging platform 104. In an implementation where only a copy of the message was provided to the message evaluation server 106, an indicator or pass value (check value) referencing the evaluated message is passed back to the messaging platform 104. Upon receipt of the check value, the messaging platform 104 is configured by one or more transmission modules 303 to send the message to the intended recipients(s).

### Obtaining Resource Requests

With particular reference to FIG. 8, a resource request is using a particular web server platform 111 (e.g. via a web browser). Here, the web server platform 111 routs the request to the resource evaluation server 112. For example, the web server platform 111 is configured to store all incoming requests into temporary buffer or storage location. From this storage location, a copy of the request is provided to the resource evaluation server 112. Building on this example, a resource request access module 502 configures a processor of the resource evaluation server 112 to access or receive the request (or a copy thereof) from the web server platform 111. In one implementation, the resource request access module 502 includes one or more submodules to configure communication between the processor and a message storage buffer or database. In one particular implementation, an authentication submodule configures the processor of the resource evaluation server 502 to gain access to the request storage database by providing authentication data or credentials. Furthermore, a formatting submodule can configure the processor(s) of the resource evaluation server 502 to capture the content of the request and transform the content into a format or form suitable for use.

### Evaluating the Message

After the content evaluation module 304 of the message evaluation server 106 identifies a resource access link within the content of the message (as in step 204), or the content evaluation module 504 of the resource evaluation server 112 extracts a resource access link, the extracted resource access link is accessed and the content referred to by the link is evaluated, as in step 206. In one or more implementations, the extracted access link is an unknown link and references or refers to unknown content. Here, the content of the link is accessed, such as through a viewer or player. For instance, the accessed content can be displayed in a separate viewer window generated by the content evaluation module for visual inspection by a user. Alternatively, the content evaluation modules 304, 504 configure one or more processors of the message evaluation server 106 or resource evaluation server 112 to evaluate the content referred to by the link automatically. It is to be appreciated that content evaluation is performed regardless of the medium in which the resource link arrives (e.g., a message versus a communication from a browser or manually entered) so that the evaluation modules of the message evaluation server and resource evaluation server (FIGS. 3 and 8) can be configured using similar or the same code and submodules, and can execute similar or the same operations.

By way of non-limiting example, the content evaluation module 304, 504 can configure a processor 106 to extract or identify a content fingerprint or watermark from the referred content. For instance, the content evaluation server(s) are configured to evaluate the content referred to by the access link in a sandboxed environment (e.g. virtual machine). Such sandboxed environments can, in particular implementations, allow the referred content to be evaluated for identification purposes as well as to determine if the referred content contains malicious components.

As used herein, a content fingerprint is an inherent identifier of each piece of content. Specifically, the content fingerprint functions as a native watermark that does not need to be applied to content, and is derived from the characteristics of the content itself. In a particular implementation, the content fingerprint is one or more representations of a portion, or the entirety, of the accessed content. For example, the content fingerprint exists as numerical or graphical representation of the content. In another implementation, the content fingerprint is a collection of images and/or sounds excerpted from the content. For example, content fingerprint is generated using image recognition submodules of the content evaluation module 304/504 to identify words, scenes or patterns within a video portion of the content. In a particular implementation, the content fingerprint is one or more extracted patterns present within in a data stream or audio signal corresponding to the content. Additionally, the content fingerprint can include a transcription of the audio data corresponding to the content. Here the transcription of an audio source is generated by one or more transcription submodules of the content evaluation module 304/504. In a further implementation, the content fingerprint is a dataset or data object that includes one or more variables identifying the content, such as content length, format, type, encoding, bit stream values or other data values representative of a particular piece of content.

In certain embodiments, the content fingerprint can include any watermarks applied during or after the creation of the content.

The content evaluation module 304/504 configures a processor of the message evaluation server 106 or the resource evaluation server 504 to compare the extracted or identified content fingerprint against a database of content fingerprints. In one particular implementation, the content database 108 includes one or more entries representing the content fingerprints of known content. The extracted or identified content fingerprints of the unknown content are compared to the fingerprints of known entries. Where a match is identified between the extracted or identified content fingerprint and a database entry, the extracted or identified content fingerprint is associated with the known entry.

In one or more implementations, the content or a portion thereof is transmitted by the relevant evaluation server to a remote third-party evaluation system. Here, the evaluation server sends a request to a third-party service to identify, using the content fingerprint, the content. Upon evaluation of the content, the third-party evaluation service provides the content evaluation server 106 with data about the content, such as the title, ownership information or other identifying data. If the third-party evaluation server indicates that such content is restricted content, then the link in the message evaluated by the content evaluation server will be altered accordingly.

In an alternative configuration, the content evaluation module 304/504 configures one or more processors of message evaluation server 106 to identify content identification tags or markers incorporated into the content. Here, a video file originally produced by a content creator may include one or more standardized or known watermarks. The watermark is, in a particular implementation, an image, icon, tone sequence, text, data or any combination thereof. Such watermarks may be incorporated into one or more frames of a video stream, or provided in one or more audio channels of an audio-video or audio stream. For example, a watermark is an image that is superimposed on a portion of the content at the time of encoding or creation. Alternatively, the watermark can be a post encoding manipulation of the content, such as the removal or alteration or one or more-pixel values making up an image or series of frames in video content. Likewise, the watermark can be an additional audio channel added to an audio file or stream. Alternatively, additional audible or inaudible shifts in tone, treble, base or other characteristics of audio content are altered or manipulated. For example, the watermark or content identification is provided in one or more primary or secondary audio channels, subtitle channels, alternative language channels or video channel. The watermark may contain an identifier indicating the title and/or source of the content. However, in one or more implementations, the watermark provides an alphanumeric value, code or index.

As described herein, the content evaluation module 304/504 configures a processor of the message evaluation server 106 or resource evaluation server to extract or identify the watermark. The watermark is compared to a content identification database 108. Here, the content database 108 includes an entry indicating the source of the watermark and the ownership details of the content to which the watermark is applied. In one or more implementations, the watermark is converted into a code or index that can be used to search the content identification database. Alternatively, the content evaluation module accesses an instruction set for various watermarks stored in a database. This instruction set indicates one or more processes or procedures to identify a watermark within the evaluated content. For instance, the instruction set of watermarks may instruct a content player to or processor to extract a frame of an video file at a given time and evaluate the pixels of the frame. Here the pixels of the indicated frame might themselves be the watermark. Based on a evaluation of the pixels, the processor configured by the content evaluation module 304/504 may identify authorized content. In another example, the instruction set of watermarks could indicate an audio channel or frequency to evaluate. Where the evaluated content does not match the anticipated watermark, or the characteristics of the evaluated content are such that a watermark is not identified, the content may be flagged for further processing or labeled as restricted access content.

With particular reference to FIG. 1, the content identification database is one or more databases 108 in communication with to the processor of the message evaluation server 106. The physical structure of the database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art. The database 108 includes the necessary hardware and software to enable a processor local to the message evaluation server 106 to retrieve and store data within the database 108. The entries of the content identification data are used to identify the content (such as by title). Furthermore, the entries in the content database may identify the content creator, as well as an authorized retailer of the content.

In a further example, the one or more content evaluation modules 304/504 configure the relevant content evaluation server(s) to evaluate the content for digital signatures, or copyright notices to determine the nature and form of the content. For example, where the extracted access link refers to audio file content, the content evaluation server(s) are configured by one or more evaluation modules to identify copyright notices or digital signal tags or meta data associated with the content and compare that content.

In an alternative example, the access link is evaluated against a database of known links that direct users to restricted access content. For example, a processor of the message evaluation server 106 and/or resource evaluation server 112 is configured by a respective access or link comparison module 306 or resource link comparison module 506 to compare the string representing the extracted access link to one or more entries within the database 108 of access links. The entries within the database 108 are, in one implementation, a list of prohibited sites known for distributing restricted access content. Such lists and similar records are herein referred to as access link blacklists. Alternatively, the database is a collection of preapproved sites that have permission to distribute content and are referred to as whitelists. In a further arrangement, the database can include both prohibited and preapproved sites. Regardless, the database 108 can store information in encrypted form. The database 108 can be behind one or more firewalls to restrict access to only include requests from the message evaluation server 106 or resource evaluation server 112, which in turn can include security features to thwart malicious access.

The access link comparison module 306/506 configures a processor of the message evaluation server 106 and/or resource evaluation server 112 to evaluate the domain name of the extracted link against the list of entries within the access link database. Alternatively, or in addition, the message evaluation server 106 can evaluate the top-level domain or country-code top level domain, any directory/extension that follows the top level domain, any subdomain, or a combination of the foregoing, against the list of entries within the access link database. Alternatively, a processor of the message evaluation server 106 and/or resource evaluation server 112 is configured by one or more submodules of the access link comparison module 306/506 to evaluate the entire access link against the entries within the database. In yet a further implementation, a processor of the message evaluation server 106 and/or resource evaluation server 112 is configured to evaluate the IP address corresponding to the link and compare the IP address against a list of known or suspected restricted content supplier IP addresses. For example, where there is at least a match between the IP address on a blacklist and the restricted access content link, the restricted access content links is determined to be restricted access.

In a further implementation, one or more estimation submodules of the access link comparison module 306/506 are used to generate a probability, or degree or similarity, between the extracted access link and one or more entries within the database. For example, a processor of the message evaluation server 106 and/or resource evaluation server 112 is configured to identify any entry within the database that has more than as pre-determined percentage similarity of characters of one or more entries within the database. For example, where the percent similarity between an extracted access link and a database entry is more than a threshold amount then such links are treated as a match. As a non-limiting example, the threshold amount can be a match that scores 70% or more based on a prescribed criterion or criteria, including any of the foregoing, or based on the domain name matching and thus providing the threshold amount for scoring as a match, even though a directory or extension does not match to the database. For instance, where certain domain names and/or top-level country domains are known to be a source of restricted content, such domain names and top-level domains are assigned a predictive weight related to the likelihood that the link is referencing restricted content. In circumstances where the top-level domain stays the same, but the subdomain changes with each new item of linked content there are an extremely large number of potential iterations of links. Therefore, the predictive weight is used to determine the probability of similarity between an unknown link and a known link that points to restricted content. For instance, a known link is www.knownlink.com/001. An unknown link may be www.knownlinkA.com/AAA. Here, there is both a change in the subdomain (001 compared to AAA) and the top-level domain (“knownlink” compared to “knownlinkA”). A comparison of links, such as one made by comparing the percentage of similarity of the characters in the link, can be used to generate a predictive value that the unknown link is provided by the same entity as the known link. Further factors, such as hosting data, account data or DNS (Domain name server) data can be included in one or more algorithms that together generate the predictive value. Depending on the threshold values of the predictive weight, the message evaluation system described automatically adds the unknown link to either the white list or black list based on the predicted status.

Thus, the message evaluation server 106 and/or the resource evaluation server 112 are configured to evaluate extracted access links even when there is not an exact (100%) match within the database.

In a particular implementation, one or more content evaluation servers, computers or platforms (not shown) in communication with the message evaluation server 106 and/or resource evaluation server 112 are configured to evaluate content referenced by the extracted access link as described above. Upon matching an extracted link to restricted content, the previously unknown extracted link is added to the restricted link database. Furthermore, where the restricted content is offered by approved vendors, but the content is identified as restricted (such as by an entry in the Content ID database corresponding to the content) the link is removed or altered as described in further detail herein.

In an implementation where a match within a prescribed criterion or criteria is not made using a blacklist or a match is made using a whitelist, the message is provided back to the messaging platform 104 or web server platform 111 for eventual transmission to the intended recipient(s) as in step 208.

With continued reference to FIG. 2, messages containing content matched to an entry in the blacklist are evaluated by the processor(s) configured by a message modification module 310 as in step 210. In one implementation, the message modification module 310 configures a processor of the message evaluation server 106 to replace the identified access link with a notice or place holder text. In a further arrangement, the replacement text is formatted to provide information to the intended recipient that the message contains restricted access material.

Returning to FIG. 4, the non-resource link content 402 of an evaluated message 401 is unaltered. However, the restricted access content link 404A is modified and replaced with replacement text 404B in a modified version 406 of the message 401. In one arrangement, a new message is generated with the modified content. However, in one or more alternative configurations, the original content of the message 400 (or a copy thereof) is modified directly by message evaluation server 106 to yield the altered message 401.

In an alternative arrangement, a processor of the message evaluation server 106 is configured by one or more submodules of the message modification module 310, to replace the restricted access link with a replacement content access link. Similarly, a processor of the resource evaluation server 112 is configured by one or more submodules of a content modification module 508 to replace a restricted access link with a replacement content access link. Here, the entries in the restricted access database 108 have corresponding entries that provide an alternative, permitted access link to the desired content. A processor of the message evaluation server 106 and/or resource evaluation server 112 is configured to identify from a database, such as database 108, the alternative access link and add the alternative access link to the message content so as to replace the restricted content link. As used herein, the access link database is a collection of assets, such as video or audio content that is available to subscribers to various content vendors, services or platforms.

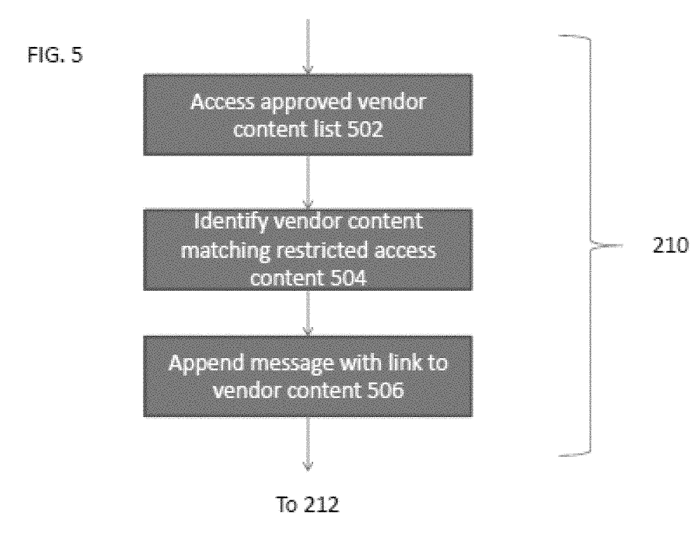

In yet a further implementation, a processor of the message evaluation server 106 is configured by one or more recipient identification modules 312 to identify a user identity of the intended recipient. Similarly, a processor of the resource evaluation server 112 is configure by one or more requester identification modules 510 to identify a user identify of content requester. For example, where the message is sent within a social network application where the recipient has registered an account, the account information is provided to the processor of the message evaluation server 106. Similarly, a browser program operating on the requester device can include metadata indicating the identity of the current user of the device in communications to the resource evaluation server 112. Here, and with reference to FIG. 5, the recipient identification module 312 and/or requester identification module 510 accesses one or more customer lists for approved content vendors providing permitted access to the content linked to by the restricted access link as in step 502. Where the intended recipient or content requester is identified as an account holder with one or more approved content vendors (e.g. Netflix®, Amazon Video®, or Vudu®) a processor of the message evaluation server 106 and/or resource evaluation server 112 is further configured to access the content library of the one or more approved content vendors as in step 504. Through configuration by a vendor content search module 314/512, a processor matches the content identified by the resource link (or a pre-determined entry corresponding to the resource link is the database) with content offered by the approved vendor. In a particular implementation, the vendor content search module configures a processor to communication with one or more third party content search platforms. Such search platforms maintain a database of content and approved vendors. Here, the vendor search module 314/512 transmits a request query to the one or more third party content search platforms requesting the content identified by the content Id or content databases. The third-party search platforms in turn respond with a dataset that includes one or more permitted access links to the searched content.

Upon receipt, the permitted access link is appended to the message as provided in step 506. Thus, the restricted content link is replaced with a link to the same content, but the link routes the recipient to a vendor of the content that the recipient already uses.

In a further implementation, the message evaluation server 106 and/or resource evaluation server 112 only receives the extracted link from the message server 104 and/or web server platform 111. Here, the message evaluation server 106 and/or resource evaluation server 112 is configured to delay the delivery of messages containing access links until receipt of a pass value for that message that is above a given threshold value. Here, the message evaluation server 106 and/or resource evaluation server 112 generates a delivery value greater than the pass value threshold when the received content access link is matched to an entry in the database, and a delivery value less than the pass value threshold when the received content access link is not matched to an entry in the database. In the described implementation, where the delivery value is above the pass value threshold, only the delivery value is passed back to the messaging platform 104 and/or web server platform 111. if the delivery value is below the threshold both the delivery value, and either replacement text or a replacement link are provided back to the messaging platform 104 and/or web server platform 111 either for incorporation into the message content, or for rerouting to another link as the case may be.

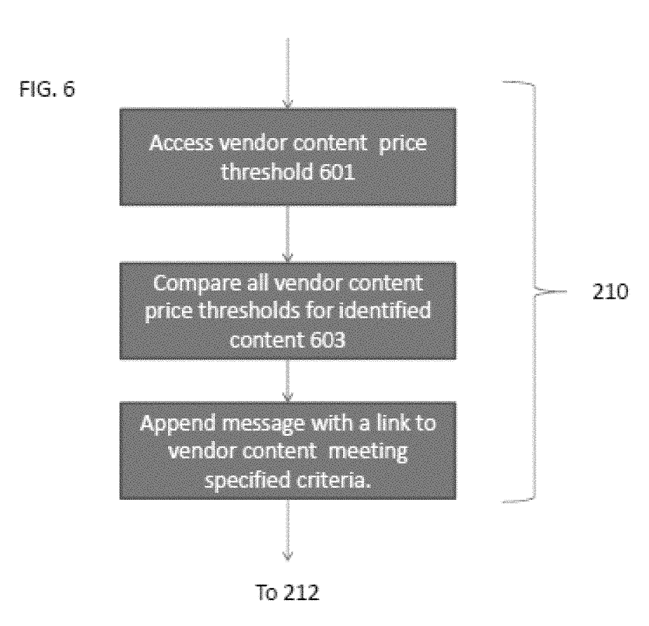

As provided in FIG. 6, a processor of the message evaluation server 106 and/or resource evaluation server 112 is configured by one or more auction modules 316/514 to select content from a plurality of approved vendors offering the content. Here, the auction module 316/514 configures a processor of the message evaluation server 106 and/or resource evaluation server 112 to permit one or more vendors of the approved content to set a price for access to the approved content as in step 601. For example, a vendor through one or communication interfaces with the message evaluation server 106 or resource evaluation server 112 sets a threshold price for one, some or all content provided by the vendor. The auction module 316/514 further configures a processor of the message evaluation server 106 and/or resource evaluation server 112 to select a particular vendor based auction criteria. For example, if the auction criteria(ion) is a lowest price for content, the auction module 316/514 causes a processor of message evaluation server 106 or resource evaluation server 112 to select the access link corresponding to the vendor supplied content having the lowest price as shown in step 603. Thus, when the message content is modified by a processor configured by the message or content modification modules 310/508, the substituted link corresponds to the winning bid of the auction.

Upon modification of the message, the modified message 406 is provided to the messaging platform 104 for transmission to the intended recipient. Similarly, a modified link can be provided to web server platform 111 via a communication module 516 for redirecting a browser to authorized content. With reference to step 212, a processor configured by a communication module 318 transmits the modified message, or the content portion of the message back to the messaging platform 104 for transmission to the recipient. For example, the messaging platform 104 opens one or more connections to the internet and routes the message to the intended recipient device. Alternatively, the message is placed within the mailbox or message center of a messaging application. Upon recipient of a message to the mailbox or message center, a notification of the message is sent to the user informing them of the message.

In one or more implementations, the user may opt into the content evaluation system provided by accessing or downloading software modules to the user device. Alternatively, where a user accesses a communication or messaging platform, the user may select or opt to have its messages evaluated by the content evaluation system. Here, the communication platform provides communication links and routing of messages to the content evaluation system for users that have opted into the content evaluation system.

In some implementations, the resource evaluation server includes a managing user control module. As used herein, the managing user has access or control over one or more user devices. The managing user control module permits the access or download of one or more modules that provides or enables the content evaluation system on that device. For instance, the management control module can be used to set resources as restricted or unauthorized depending on the identity of the requester. For example, as users have different log in IDs on various devices, a management control module can set certain sites to be restricted when a user (such as a child or employee) is logged onto the device.

The managing user control module application can operate in tandem with content scanner applications preferably residing but at least readily accessible by end user devices. When a content scanner 114, 116 checks content about to play, it performs operations similar to the content evaluation modules of the message evaluation and resource evaluation servers. That is, the content scanner reviews the content to determine if there any content fingerprints, as discussed above, are indicative of authorized/unauthorized access. If indicia suggesting restricted content (or a lack of indicia indicating authorized content) is detected, an industry ID3 tag can be looked up which enables the content scanner to identify unique industry ID for the content. This can then be sent to an authorized service such as iTunes, Amazon, and/or Google Play to offer the consumer the opportunity to access authorized content (i.e., buy or rent content they were attempting to watch).

In one or more further implementations, the present invention includes a method of managing a request for a restricted access content link to a non-restricted content link, the method comprising: receiving, by a processor configured with code, a request to access a restricted access content link; extracting, by a processor configured with code, the restricted access content web link from the request; evaluating content referred to by the restricted content access link; comparing the content of the access link to one or more entries stored in a content identification database; and amending, by a processor configured with code, the content access link when the extracted content identification database is matched to an entry in the database so as to redirect the request to a non-restricted content link.

In one or more further implementations, the present invention includes a method of sanitizing a message of restricted access content links, the method comprising: receiving, by a processor configured with code, at least one message having a content portion containing at least one content access link from a message routing appliance and a routing portion containing intended recipient data; extracting, by a processor configured with code, the at least one content access link from the message; evaluating the content referred to by the access link, comparing the content of the access link to one or more entries stored in a content identification database, amending, by a processor configured with code, the content portion of the at least one message to remove the content access link when the extracted content identification database is matched to an entry in the database; and providing, by a processor configured with code, the amended message to the message routing appliance.

In one or more further implementations, the present invention includes a method of preventing playback of restricted media content comprising: receiving a link to media content; prior to playback of the media content, scanning the media content for a content fingerprint indicative of whether the media content is authorized; if a content fingerprint indicative of an authorized source is found in the media content activating a media player to playback the media content; otherwise: determining an industry identification in the media content; and sending the industry identification of the media content to an authorized content source to provide the ability to obtain an authorized version of the media content.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features.

1. A message evaluation system for processing restricted content, the message evaluation system including:
a content database; and
a processor, having a memory and configured by code implemented thereto:
receive at least one message having a content portion containing at least one content access link from a message routing appliance and a routing portion containing intended recipient data,
extract the at least one content access link from the message,
evaluate the content referred to by the access link,
compare the content of the access link to one or more entries stored in the content database,
amend the content portion of the at least one message to remove the content access link when the extracted content is matched to an entry in the database, and
provide the amended message to the message routing appliance.

2. The message server of claim 1, wherein the processor is further configured by code to:
replace the extracted content access link with one or more pre-determined placeholder text strings.

3. The message server of claim 1, wherein the processor is further configured by code to:
send the extracted access link to a playback server;
identify one or more content identifiers within the content; and
query the content database using one or more of the identified content identifiers.

4. The message server of claim 1, wherein the system further comprises a content link database accessible to the processor and configured to provide one or more links to approved vendor content.

5. The message server of claim 4, wherein the processor is further configured by code to:
access the approved content link database,
query one or more content link databases for approved links to the content referred to by the extracted content access link,
receive one or more links to the content in response to the query, and
replace the extracted content access link with the at least one of the received links.

6. The message server of claim 5, wherein the processor is configured by a selection module to:
receive one or more content access prices associated with each of the links to the content in response to the query;
select, based on one or more selectin criteria, one of the one or more permitted access links, where the selection criteria include the content access prices; and
amend the content of the message to include the selected permitted access link.

7. A message evaluation system for processing restricted content, the message evaluation system including:
a message server configured to delay the delivery of a message sent using the message server until receipt of a pass value above a given threshold value;
an access link database; and
a processor, having a memory and configured by code implemented thereto:
receive from a message server, at least one content access link obtained from a message sent using the message server;
compare the received content access link to one or more entries stored in the access link database,
generate a delivery value greater than the pass value threshold where the received content access link is matched to an entry in the database and a delivery value less than the pass value threshold where the received content access link is not matched to an entry in the database; and
provide at least the delivery value to the message server as a pass value.

8. The message server of claim 7, wherein the processor is further configured by code to:
provide replacement content to the message server when the delivery value is below the threshold value.

9. A resource evaluation system for processing restricted content, the resource evaluation system including:
a content database; and
a processor, having a memory and configured by code implemented thereto:
receive at least request containing at least one content access link from a sender device,
extract the at least one content access link from the request,
access a database including a list of restricted access link entries;
compare the extracted content access link to the list of the database;
remove the content access link if the extracted content is matched to an entry in the database, and
provide a notification that access has been restricted to the content access link.

10. The resource evaluation system of claim 9, further comprising:
accessing the content access link to obtain media content data associated with the content access link;
determining whether the obtained media content data contains a content fingerprint indicative of an authorized source; and
routing the media content associated with the content access link back to the sender device if is determined that a content fingerprint indicative of an authorized source is present within the obtained media content.

11. The resource evaluation system of claim 9, wherein the processor is further configured by code to:
replace the extracted content access link with one or more pre-determined placeholder text strings.

12. The message server of claim 9, wherein the processor is further configured by code to:
send the extracted access link to a playback server;
identify one or more content identifiers within the content; and
query the content database using one or more of the identified content identifiers.

13. The message server of claim 9, wherein the system further comprises a content link database accessible to the processor and configured to provide one or more links to approved vendor content.

14. The message server of claim 9, wherein the processor is further configured by code to:
access the approved content link database, query one or more content link databases for approved links to the content referred to by the extracted content access link, receive one or more links to the content in response to the query, and replace the extracted content access link with the at least one of the received links.

15. The method of claim 14, wherein the content fingerprint comprises at least one of a watermark and a content ID.
